(19) United States
(12) Patent Application Publication
(10) Pub. No.: US 2022/0023017 A1
(43) Pub. Date: Jan. 27, 2022

(54) OFFSET GINGIVAL OVERLAY DENTURES

(71) Applicant: Global Dental Science, LLC, Scottsdale, AZ (US)

(72) Inventors: Timothy C. Thompson, Fountain Hills, AZ (US); Jerry Gaubert, Baton Rouge, LA (US); Becky Licon, Gilbert, AZ (US)

(21) Appl. No.: 15/284,481

(22) Filed: Oct. 3, 2016

Related U.S. Application Data
(60) Provisional application No. 62/235,872, filed on Oct. 1, 2015.

(51) Int. Cl. A61C 13/02; A61C 13/24; A61C 13/08; A61C 13/09

(52) U.S. Cl. CPC A61C 13/02; A61C 13/09; A61C 13/082; A61C 13/24

(57) ABSTRACT

An offset gingival overlay denture is provided. An offset gingival overlay denture may include a denture core and a gingival overlay extending over a portion of the denture core. The denture core may provide support to artificial dentition structures, such as teeth, and a gingival overlay may simulate natural mucosa, such as gum tissue.

### FIELD OF INVENTION

The present invention relates to the field of dentures. More particularly, the present invention relates to dentures having an offset gingival overlay.

### BACKGROUND OF THE INVENTION

Dentures have been manufactured for centuries to replace all or part of an individual's dentition. Dentures have been manufactured by molding the denture from casts made of the patient's edentulous or partially edentulous ridges. The manufacturing process may begin with a preliminary impression of the patient's mouth, which is usually done in silicone or alginate. This impression may be used to prepare a diagnostic cast. While making the impression, the dentist applies pressure to the soft tissues to simulate biting force and extends the borders of the mold to adjacent toothless areas to allow the dentures to better adapt to the gums. A final cast may then be formed from gypsum based on the diagnostic cast. The final cast may be filled or “waxed up” to form the denture. The denture teeth will be set in the wax. The cast with the waxed denture will be placed in a mold and injected or packed with acrylic. Once the resin has cured, the cast may be broken apart and the denture may be removed.

However, such processes are frequently time intensive and the multiple necessary steps introduce cost, delay, and expense. Furthermore, in instances where the final denture teeth are joined to corresponding cavities in the denture, the teeth are prone to separation and loosening. Moreover, such processes frequently require follow-up grinding and modification of the denture upon fitting to a patient's mouth. Thus, there is a need for a denture with improved precision, enhanced strength, and more natural aesthetic appearance.

Prior innovations also fail to adequately address the function of traditional dentures with traditional denture teeth. Dentures need to be balanced to avoid the patient's denture becoming loose or unstable during the protrusive and lateral movement of the mandible. This often requires grinding the occlusal surface of the denture teeth until the dentures remain in contact on at least three points throughout much of the movement of the mandible. Traditionally, a denture technician will set up the denture in an articulator and grind the teeth until the occlusive design of the denture is balanced. However, grinding the teeth will take away the material of the teeth, diminishing the aesthetic appearance of the teeth and functionally weakening the teeth, such as thinning the enamel of a multi-layer tooth. Thus there is an also need for a denture which is balanced, yet with unground occlusal surface (enamel) so that the denture has a more natural structure that will exhibit an improved aesthetic appearance and will not suffer from weakening of the enamel due to grinding.

Furthermore, in many dentures, for example, in those formed by machining, the base is machined first, followed by the teeth. For instance, the first layer to be formed is the denture base and the last layer to be formed is the enamel layer of the teeth. However, many manufacturing processes enhance the strength of the first layer to be formed (i.e., the denture base), for example, due to iterative molding/casting. Moreover the material forming the base is frequently less strong than the material forming the teeth and/or enamel layer of the teeth. However, in dentures, the enamel layer often experiences the greatest wear during use and needs to be the strongest layer of the denture. Thus, there is a need for a denture having enhanced strength, in addition to enhanced bonding between the teeth and the base.

### SUMMARY OF THE INVENTION

In accordance with various aspects of the present invention, an offset gingival overlay denture is disclosed. The offset gingival overlay denture may include a gingival overlay including a layer of material configured to mimic natural gingiva, and a denture core. The denture core may include a gingival core configured to support the gingival overlay, and an overlay offset having a surface offset of the gingival core configured to receive the gingival overlay.

The gingival core may also include a lingual surface, a hard palate surface, and a buccal-facial surface. The overlay offset may also include a lingual offset having a cutaway area of the lingual surface of the gingival core coincident with the lingual surface, a hard palate offset coincident with the hard palate surface, and a buccal-facial offset including a cutaway area of the buccal-facial surface coincident with the buccal-facial surface.

In various embodiments, the buccal-facial offset is at least partially bounded by a buccal-facial dentition chamfer configured to provide a transition from the buccal-facial surface of the gingival core to an artificial dentition structure.

In various embodiments, the lingual offset is at least partially bounded by a lingual dentition chamfer configured to provide a transition from the lingual surface of the gingival core to an artificial dentition structure.

In various embodiments, the hard palate offset is at least partially bounded by the lingual surface of the gingival core.

In various embodiments, the gingival overlay includes a buccal-facial overlay having a portion of the gingival overlay coincident with the buccal-facial offset. In various embodiments, the buccal-facial overlay covers at least a portion of the buccal-facial surface and at least partially fills the buccal-facial offset. Moreover, the buccal-facial overlay may include a buccal-facial-dentition interface edge including a terminal edge of the buccal-facial overlay proximate to the artificial dentition structures whereby a smooth transition between the buccal-facial overly and the artificial dentition structure is achieved.

The gingival overlay may include a lingual overlay having a portion of the gingival overlay coincident with the lingual offset.

The lingual overlay may cover at least a portion of the lingual surface and at least partially fill the lingual offset. The lingual overlay may include a lingual-dentition interface edge forming a terminal edge of the lingual overlay proximate to the artificial dentition structures whereby a smooth transition between the lingual overly and the artificial dentition structure is achieved.

The gingival overlay may include a hard palate overlay including a portion of the gingival overlay coincident with the hard palate offset. The hard palate overlay may cover at least a portion of the hard palate surface and at least partially fill the hard palate offset. The hard palate overlay may include a palatine raphe apex forming a region of thickening corresponding to the location of a natural palatine raphe.

In various embodiments, the denture core further includes an edentulous ridge interface surface having a shape corresponding to a patient's edentulous ridge. Moreover, the edentulous ridge interface surface may have at least one hamular notch interface surface forming a shape corresponding to a patient's hamular notch.

A denture core may include a gingival core configured to support a gingival overlay, a artificial dentition structures formed integrally with the gingival core, and an overlay offset including a surface offset of the gingival core configured to receive the gingival overlay.

The gingival core may also include a lingual surface, a hard palate surface, and a buccal-facial surface. The overlay offset may include a lingual offset including a cutaway area of the lingual surface of the gingival core coincident with the lingual surface, a hard palate offset coincident with the hard palate surface, and a buccal-facial offset including a cutaway area of the buccal-facial surface coincident with the buccal-facial surface.

A method of making an offset gingival overlay denture is disclosed. The method may include forming a denture core including a gingival core configured to support a gingival overlay, and an overlay offset having a surface offset of the gingival core configured to receive the gingival overlay. The method may include attaching the gingival overlay to the denture core.

In various embodiments the method may further include the gingival core further having a lingual surface, a hard palate surface, and a buccal-facial surface, wherein the overlay offset further includes a lingual offset having a cutaway area of the lingual surface of the gingival core coincident with the lingual surface, a hard palate offset coincident with the hard palate surface, and a buccal-facial offset including a cutaway area of the buccal-facial surface coincident with the buccal-facial surface. The gingival overlay may include a buccal-facial overlay, a lingual overlay, and a hard palate overlay. The step of attaching the gingival overlay to the denture core may include attaching the buccal-facial overlay to the buccal-facial surface coincident with the buccal facial offset, attaching the lingual overlay to the lingual surface coincident with the lingual offset, and attaching the hard palate overlay to the hard palate surface coincident with the hard palate offset.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 depicts a block diagram of a denture comprising a denture core and a gingival overlay, in accordance with various embodiments;

FIG. 2A depicts a front perspective view of a denture core of a denture;

FIG. 2B depicts a bottom view of of an upper denture core of a denture, in accordance with various embodiments;

FIG. 3A depicts depicts a front perspective view of a denture core of a denture according to FIGS. 2A-B, with an overlay offset, in accordance with various embodiments;

FIG. 3B depicts a bottom view of of an upper denture core of a denture, FIGS. 2A-B, with an overlay offset in accordance with various embodiments;

FIG. 3C depicts a top view of an upper denture core of a denture, FIGS. 2A-B, with an overlay offset, in accordance with various embodiments;

FIG. 4A depicts a front perspective view of an upper denture core of a denture, in accordance with various embodiments of a denture core with an overlay offset according to FIGS. 3A-C, with a gingival overlay, in accordance with various embodiments;

FIG. 4B depicts a bottom view of an upper denture core of a denture, in accordance with various embodiments of a denture core with an overlay offset according to FIGS. 3A-C, with a gingival overlay, in accordance with various embodiments;

FIG. 4C depicts a top view of an upper denture core of a denture, in accordance with various embodiments of a denture core with an overlay offset according to FIGS. 3A-C, with a gingival overlay, in accordance with various embodiments;

FIG. 5 illustrates a side view of an exemplary balanced occlusion motion envelope defined in protrusion and laterotrusion;

FIG. 6 illustrates a top view of an exemplary balanced occlusion motion envelope defined in protrusion and laterotrusion;

FIG. 7 illustrates a side view of an exemplary artificial dentition structure; and

FIG. 8 illustrates a method of forming an offset gingival overlay denture.

FIG. 9 illustrates a cross-section view of a denture core of a denture; according to an embodiment of the invention;

FIG. 10 illustrates a cross-section view of a denture core having an overlay offset removed from the denture core, according to an embodiment of the invention;

FIG. 11 illustrates a cross-section view of a denture core having a gingival overlay applied to the denture core having the overlay offset removed, according to an embodiment of the invention;

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

For the sake of brevity, conventional techniques for manufacturing and construction may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical method of construction.

Recent developments in fully milled monolithic dentures have led to the creation of stronger dentures. For instance, various related systems and methods for manufacturing dentures are provided in pages 3-24 of U.S. patent application Ser. No. 14/195,348, entitled “SYSTEM AND METHOD FOR MANUFACTURING LAYERED DENTURES” and filed on Mar. 3, 2014 and pages 3-18 of U.S. patent application Ser. No. 13/830,963, entitled “SYSTEM AND PROCESS FOR MANUFACTURING OF DENTURES” and filed on Mar. 14, 2013, and are incorporated by reference herein. For instance, various offset gingival overlay dentures as discussed herein may be applied to the aspects incorporated by reference.

Similarly, various systems and methods for molding thermosetting plastics, such as to form various features of the offset gingival overlay dentures disclosed herein are provided in pages 2-11 of U.S. patent application Ser. No. 13/369,238, entitled “PROCESS AND SYSTEMS FOR MOLDING THERMOSETTING PLASTICS” and filed on Feb. 8, 2012 and are incorporated by reference.

Moreover, various systems and methods for reference and registration of implant supported dentures such as for use in combination with various teachings herein are provided in pages 3-22 of U.S. patent application Ser. No. 14/013,295, entitled “DENTURE REFERENCE AND REGISTRATION SYSTEM” and filed on Aug. 29, 2013 and are incorporated by reference, as are various systems and methods for reference and registration of implant supported dentures such as for use in combination with various teachings herein which are provided in pages 3-22 of U.S. patent application Ser. No. 14/698,649, entitled “DENTURE REFERENCE AND REGISTRATION SYSTEM” and filed on Apr. 28, 2015, and which are also incorporated by reference.

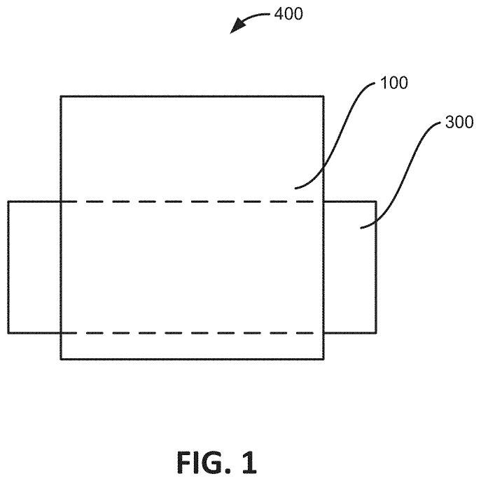

Now, with reference to reference to FIG. 1, an offset gingival overlay denture 400 may comprise a denture core 100 and a gingival overlay 300. An offset gingival overlay denture 400 may provide an artificial replacement for all or part of a patient's dentition. For instance, a denture may be configured to replace all or part of mandibular dentition, or maxillary dentition, and in various embodiments, to further replace all or part of a patient's gingiva and/or edentulous or partially edentulous ridges.

A denture core 100 may comprise a primary structural support of an offset gingival overlay denture 400. For instance, a denture core 100 may include artificial teeth, artificial gingiva, and/or structural members.

A gingival overlay 300 may comprise a layer of material attached to the denture core 100 and configured to imitate natural gingiva, for instance, having a color, hue, gloss, shape, and/or other features configured to imitate a patient's natural gums.

In various embodiments, a denture core 100 may have an intaglio portion and a festooned portion. In other words, an gingival overlay 300 may be attached to the denture core 100, such as on a festooned portion. In various embodiments, the intaglio portion interfaces with a patient's anatomical features, such as edentulous or partially edentulous ridge(s). In various embodiments, the festooned portion receives a gingival overlay.

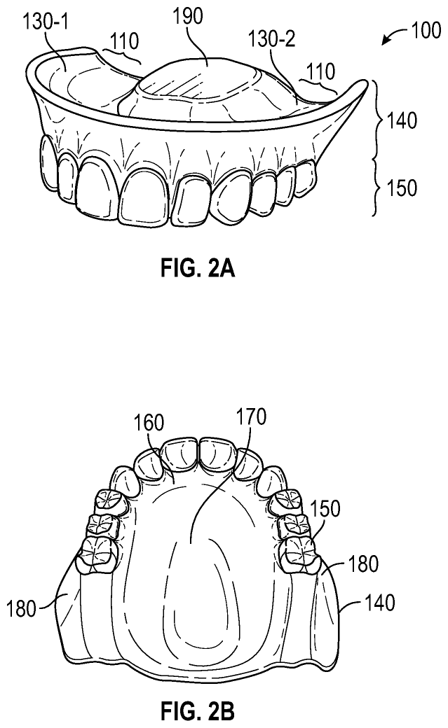

With reference to FIGS. 2A-B, a denture core 100 may comprise various additional aspects. For instance, a denture core 100 may comprise an edentulous ridge interface surface 110. An edentulous ridge interface surface 110 may comprise a surface of the denture core 100 comprising a shape corresponding to the patient's edentulous (whether fully edentulous or partially edentulous) ridge(s). For instance, in various embodiments, the edentulous ridge interface surface 110 may comprise irregular patterning, for instance, hills, valleys, ridges, depressions, and/or the like formed to correspond to the irregular patterning of a patient's edentulous ridges, and/or surrounding mucosa. For instance, a edentulous ridge interface surface 110 may comprise a first hamular notch interface surface 130-1 and a second hamular notch interface surface 130-2 positioned to receive corresponding hamular notches of an edentulous ridge. In this manner, the denture core 100 may be securely positioned in fixed registration relative to a patient's anatomical features. In various embodiments, the interaction of the edentulous ridge interface surface 110 with the patient's anatomical features induces suction between the denture core 100 and the patient's anatomical features, whereby the denture core 100 is secured in position. In further embodiments, the edentulous ridge interface surface 110 is further configured to receive an adhesive layer, liquid, gel, implant, and/or the like, whereby the denture core 100 may be secured in position.

Moreover, the denture core 100 may comprise a palatal interface surface 190. Similar to the edentulous ridge interface surface 110, the palatal interface surface 190 may comprise a surface of the denture core 100 comprising a shape corresponding to aspects of a patient's anatomy. For example, the palatal interface surface 190 may comprise a shape corresponding to a patient's hard palate and/or soft palate. For instance, in various embodiments, the palatal interface surface 190 may comprise irregular patterning, for instance, hills, valleys, ridges, depressions, and/or the like formed to correspond to the irregular patterning of a patient's hard palate and/or soft palate, and/or surrounding mucosa. In this manner, the denture core 100 may be securely positioned in fixed registration relative to a patient's anatomical features. In various embodiments, the interaction of the palatal interface surface 190 with the patient's anatomical features induces suction between the denture core 100 and the patient's anatomical features, whereby the denture core 100 is secured in position. In further embodiments, the palatal interface surface 190 is further configured to receive an adhesive layer, liquid, gel, implant, and/or the like, whereby the denture core 100 may be secured in position.

The denture core 100 may comprise artificial dentition structures 150. The artificial dentition structures 150 may comprise artificial teeth. In various embodiments, the artificial dentition structures 150 are integrally formed with aspects of the denture core 100, such as a gingival core 140 of the denture core 100. In various embodiments, the denture core 100, including the gingival core 140 and the artificial dentition structures 150 are formed from a unitary block of material. In further embodiments, the artificial dentition structures 150 may comprise artificial dentition structures 150 having multiple layers. For instance, various related systems and methods for manufacturing artificial dentition structures 150 are provided in pages 3-24 of U.S. patent application Ser. No. 14/195,348, entitled “SYSTEM AND METHOD FOR MANUFACTURING LAYERED DENTURES” and filed on Mar. 3, 2014 and pages 3-18 of U.S. patent application Ser. No. 13/830,963, entitled “SYSTEM AND PROCESS FOR MANUFACTURING OF DENTURES” and filed on Mar. 14, 2013, and are incorporated by reference herein.

The denture core 100 may comprise a gingival core 140. A gingival core 140 may comprise an artificial gingiva. The gingival core 140 may comprise a plurality of surfaces oriented to mimic natural gingiva. In further embodiments, the gingival core 140 comprises a variety of surfaces configured to receive a gingival overlay 300 that mimics natural gingiva. As such, the gingival core 140 may be shaped to support a gingival overlay 300 in position to mimic natural gingiva. The gingival core 140 may comprise one or more of a lingual surface 160, a hard palate surface 170, and a buccal-facial surface 180. For instance, a buccal-facial surface 180 may comprise an outboard peripheral surface of the gingival core 140 approximating the profile of natural buccal-facial mucosa. A lingual surface 160 may correspond in relative position to natural lingual mucosa, for instance disposed inward of an array of artificial dentition structures 150 and adjoining the artificial dentition structures 150. A hard palate surface 170 may correspond in relative position to natural hard palate, for instance, disposed inward of an arcuate array of artificial dentition structures 150, such as at least partially bounded by the lingual surfaces 160.

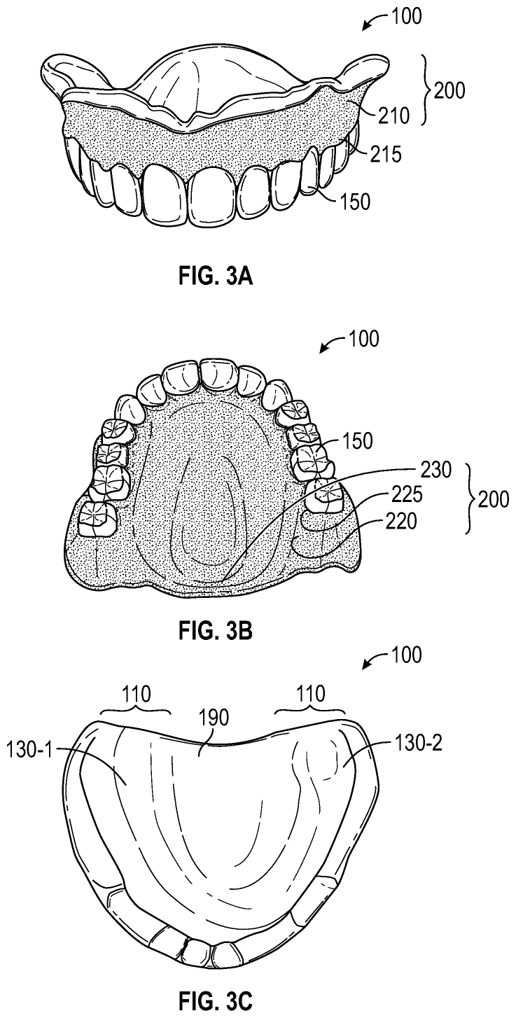

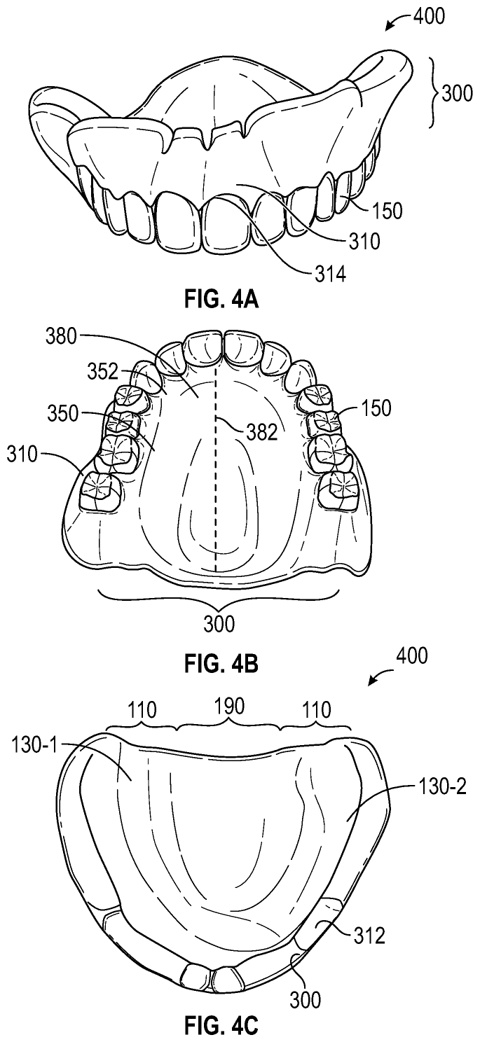

Now, with reference to FIGS. 3A-C, the denture core 100 may further comprise an overlay offset 200. An overlay offset 200 may comprise a surface offset of the denture core 100 configured to receive a gingival overlay 300 (for example, see FIGS. 4A-C). The overlay offset 200 may further comprise surface preparation, for instance, adhesion enhancing aspects configured to enhance the adhesion of a gingival overlay 300 to the denture core 100. In various embodiments, the surface preparation may comprise, scoring, roughening, texturing, such as grooves, ridges, and/or the like, whether in arbitrary arrangements, or symmetric patterns, and/or the like. In various embodiments, the overlay offset 200 may comprise differing offsets, such a corresponding to the surfaces of the gingival core 140, and the differing offsets may be of differing dimensions. For instance, the overlay offset 200 may comprise a buccal-facial offset 210 associated with a buccal-facial dentition chamfer 215, a lingual offset 220 associated with a lingual dentition chamfer 225, and/or a hard palate offset 230.

The buccal-facial offset 210 may comprise a cutaway area of the gingival core 140 coincident with the buccal-facial surface 180 of the gingival core 140. In this manner, the buccal-facial surface 180 of the gingival core 140 may be offset relative natural buccal-facial surface of natural dentition. In other words, in this manner, the buccal-facial surface 180 of the gingival core 140 may be offset to provide space for a gingival overlay 300, as will be discussed further herein. The buccal-facial offset 210 may be at least partially bounded by a buccal-facial dentition chamfer 215. The buccal-facial dentition chamfer 215 may comprise a chamfer, curvature, complex curvature, and/or the like configured to diminish or eliminate discontinuities in a transition from the buccal-facial surface 180 of the gingival core 140 to an artificial dentition structure 150. In this manner, a transition from artificial dentition structures 150 to gingival overlay 300 may be enhanced, and/or stress concentrations may be ameliorated, and/or force concentrations may be diminished.

The lingual offset 220 may comprise a cutaway area of the gingival core 140 coincident with the lingual surface 160 of the gingival core 140. In this manner, the lingual surface 160 of the gingival core 140 may be offset relative natural lingual surface of natural dentition. In other words, in this manner, the lingual surface 160 of the gingival core 140 may be offset to provide space for a gingival overlay 300, as will be discussed further herein. The lingual offset 220 may be at least partially bounded by a lingual dentition chamfer 225. The lingual dentition chamfer 225 may comprise a chamfer, curvature, complex curvature, and/or the like configured to diminish or eliminate discontinuities in a transition from the lingual surface 160 of the gingival core 140 to an artificial dentition structure 150. In this manner, a transition from artificial dentition structures 150 to gingival overlay 300 may be enhanced, and/or stress concentrations may be ameliorated, and/or force concentrations may be diminished.

The hard palate offset 230 may comprise a cutaway area of the gingival core 140 coincident with the hard palate surface 170 of the gingival core 140. In this manner, the hard palate surface 170 of the gingival core 140 may be offset relative natural hard palate surface of natural dentition. In other words, in this manner, the hard palate surface 170 of the gingival core 140 may be offset to provide space for a gingival overlay 300, as will be discussed further herein.

With reference now to FIGS. 3A-C and 4A-C, various aspects of the gingival overlay 300 are discussed.

A gingival overlay 300 may comprise a layer of material disposed in contact with the denture core 100 whereby natural gingival features may be simulated. For instance, whereas a denture core 100 may comprise white material, and/or a material simulating the appearance of natural dentition structures, a gingival overlay 300 may comprise a pink material and/or a material simulating the appearance of natural soft tissues, such as gingiva. In this manner, aesthetic features such as appearance, and functional features, such as speech formation, of the offset gingival overlay denture 400 may be enhanced. A gingival overlay 300 may be applied to a denture core 100 and may be hardened, adhering to the denture core 100. More specifically, a gingival overlay 300 is applied to the overlay offset 200 (FIGS. 3A-C) of the denture core 100.

Moreover, in further embodiments, aspects of the denture core 100, such as the artificial dentition structures 150 and/or the gingival core 140 may be formed from a pink material and/or material simulating the appearance of natural soft tissues. The offsets discussed further herein may be located in inverse locations, so that an overlay of generally white and/or dentition simulating material may be festooned thereon. Thus, while a dentition simulating denture core 100 may be festooned with mucosa simulating gingival overlay 300 as may be discussed herein, in various embodiments, the materials may be swapped and/or offsets shifted so that a denture core formed of mucosa simulating material may be festooned with dentition simulating material.

A gingival overlay 300 may comprise artificial gingiva material arranged in various portions corresponding to the surfaces of the gingival core 140. For instance, the gingival overlay 300 may comprise a buccal-facial overlay 310 associated with an edentulous ridge interface edge 312 and buccal-facial-dentition interface edge 314. The gingival overlay 300 may comprise a lingual overlay 350 associated with a lingual-dentition interface edge 352. The gingival overlay 300 may comprise a hard palate overlay 380 associated with a palatine raphe apex 382.

The buccal-facial overlay 310 may comprise a portion of gingival overlay 300 coincident with the buccal-facial offset 210. Moreover, the buccal-facial overlay 310 may extend beyond the buccal-facial offset 210, for instance, covering at least a portion of the buccal-facial surface 180. In various embodiments, the buccal-facial overlay 310 exactly fills in the buccal-facial offset 210, although in further embodiments, the buccal-facial overlay 310 may extend beyond it laterally/longitudinally along the denture core 100, and/or outwardly (e.g., with an at least partial normal vector direction component relative to the surface of the denture core 100) from the denture core 100. The buccal-facial overlay 310 may comprise surface features, such as to mimic ridges, valleys, curvature, wrinkling, and/or the like of natural mucosa. The buccal-facial overlay 310 may comprise an edentulous ridge interface edge 312 at least partially bounding the buccal-facial overlay 310. For instance, the edentulous ridge interface edge 312 may comprise a terminal edge of the buccal-facial overlay 310 proximate to the edentulous ridge interface surface 110 of the denture core 100, whereby the buccal-facial overlay 310 does not extend over the edentulous ridge interface surface 110.

Moreover, the buccal-facial overlay 310 may comprise a buccal-facial-dentition interface edge 314. The buccal-facial-dentition interface edge 314 may comprise an edge at least partially bounding the buccal-facial overlay 310. For instance, the buccal-facial-dentition interface edge 314 may comprise a terminal edge of the buccal-facial overlay 310 proximate to the artificial dentition structures 150, whereby the buccal-facial overlay 310 does not extend beyond. In this manner, a smooth transition between artificial dentition structure 150 and the buccal-facial overlay 310 may be achieved. In various embodiments, the buccal-facial-dentition interface edge 314 comprises an artificial gingival sulcus. For instance, the buccal-facial-dentition interface edge 314 may follow a path approximating a natural gingival sulcus. In further embodiments, the buccal-facial-dentition interface edge 314 directly adheres to the artificial dentition structure 150 wherein no gingival/periodontal pocket exists such that the apical bound (and a coincident coronal bound) of the buccal-facial overlay 310 is the interface of the artificial dentition structure 150 to the buccal-facial overlay 310 so that no suculus exists, although the buccal-facial-dentition interface edge 314 may be positioned to provide an aesthetic resemblance to natural dentition (e.g., coronally coincident with free gingival margin of a natural gingival tissue.) In other words, the buccal-facial overlay 310 may adhere directly against the artificial dentition structure 150 so that a periodontal probe is not insertable therebetween.

The gingival overlay 300 may comprise a lingual overlay 350 associated with a lingual-dentition interface edge 352. The lingual overlay 350 may comprise a portion of the gingival overlay 300 coincident with the lingual offset 220. The gingival overlay 300 may comprise a lingual overlay 350 covering at least a portion of the lingual surface 160. In various embodiments, the lingual overlay 350 exactly fills the lingual offset 220, although in further embodiments, the lingual overlay 350 may extend beyond it laterally/longitudinally along the denture core 100, and/or outwardly (e.g., with an at least partial normal vector direction component relative to the surface of the denture core 100) from the denture core 100. The lingual overlay 350 may comprise surface features, such as to mimic ridges, valleys, curvature, wrinkling, and/or the like of natural mucosa. The lingual overlay 350 may comprise a lingual-dentition interface edge 352. The lingual-dentition interface edge 352 may comprise an edge at least partially bounding the lingual overlay 350. For instance, the lingual-dentition interface edge 352 may comprise a terminal edge of the lingual overlay 350 proximate to the artificial dentition structures 150, whereby the lingual overlay 350 does not extend beyond. In this manner, a smooth transition between artificial dentition structure 150 and the lingual overlay 350 may be achieved. In various embodiments, the lingual-dentition interface edge 352 comprises an artificial gingival sulcus. For instance, the lingual-dentition interface edge 352 may follow a path approximating a natural gingival sulcus. In further embodiments, the lingual-dentition interface edge 352 directly adheres to the artificial dentition structure 150 wherein no gingival/periodontal pocket exists such that the apical bound (and a coincident coronal bound) of the lingual overlay 350 is the interface of the artificial dentition structure 150 to the lingual overlay 350 so that no suculus exists, although the lingual-dentition interface edge 352 may be positioned to provide an aesthetic resemblance to natural dentition (e.g., coronally coincident with free gingival margin of a natural gingival tissue.) In other words, the lingual overlay 350 may adhere directly against the artificial dentition structure 150 so that a periodontal probe is not insertable therebetween.

The gingival overlay 300 may comprise a hard palate overlay 380. The hard palate overlay 380 may comprise a portion of the gingival overlay 300 coincident with the hard palate offset 230. The gingival overlay 300 may comprise a hard palate overlay 380 covering at least a portion of the hard palate surface 170. In various embodiments, the hard palate overlay 380 exactly fills the hard palate offset 230, although in further embodiments, the hard palate overlay 380 may extend beyond it laterally/longitudinally along the denture core 100, and/or outwardly (e.g., with an at least partial normal vector direction component relative to the surface of the denture core 100) from the denture core 100. The hard palate overlay 380 may be bounded peripherally at least partially by the lingual overlay 350. The hard palate overlay 380 may comprise surface features, such as to mimic ridges, valleys, curvature, wrinkling, and/or the like of natural mucosa.

The hard palate overlay 380 may comprise a palatine raphe apex 382. For instance, a palatine raphe apex 382 may comprise a region of thickening corresponding to the location of a natural palatine raphe. In this manner, the hard palate overlay 380 may approximate the structures of natural mucosa.

With reference now to FIGS. 1-4C, and having discussed various features of an offset gingival overlay denture 400, in various embodiments an offset gingival overlay denture 400 may comprise various materials. For instance, the gingival overlay 300, and/or the denture core 100 may comprise a hardened polymethyl methacrylate (PMMA) material. However, the gingival overlay 300, and/or the denture core 100 may comprise any material having sufficiently low porosity so as to be hygienic for extended placement in a wearer's mouth. For example, the gingival overlay 300, and/or the denture core 100 may be made of a plastic, ceramic, metal, or acrylic, including for instance, a polymer, monomer, composite, or alloy.

Furthermore, the gingival overlay 300, and/or the denture core 100 and/or any other components of an offset gingival overlay denture 400 may be formed according to a process and system for molding or forming products from thermosetting plastics. Such a system may utilize a deformable container that is placed within the cavity of a housing of a mold with resins and initiator mixed therein. As a piston slides into the cavity, the upper edges of the container may engage between the housing and the piston to seal the housing from leakage. The pressure of the piston along with heat on the housing may enable the curing process to be controlled to maximize compression and minimize porosity. Exemplary processes and systems disclosed in U.S. patent application Ser. No. 13/369,238, PROCESSES AND SYSTEMS FOR MOLDING THERMOSETTING PLASTICS are incorporated by reference.

Furthermore, features of offset gingival overlay denture 400 may be machined by a CAD/CAM machining device, although any process suited for accurate forming of the material may be utilized. For example, the features may be formed by additive manufacturing, machining, etching, waterjet, laser cutting, 3D printing, or chemical mask processes.

In one example embodiment, an offset gingival overlay denture 400 may have an artificial dentition structure 1500. In one example embodiment, this structure may be at least one tooth. Said tooth may be constructed according to the principles described herein. In various embodiments the artificial dentition structure 150 may be unitary with the denture core 100 and may comprise acrylic, such as high impact acrylic though any suitable material adapted to be wear and abrasion resistant may be used. In some example embodiments, artificial dentition structure 150 may have various layers and/or artificial root structures. In various embodiments, artificial dentition structure 150 may comprise materials processed by exemplary processes and systems disclosed in U.S. patent application Ser. No. 13/369,238, PROCESSES AND SYSTEMS FOR MOLDING THERMOSETTING PLASTICS, which are incorporated by reference. In some example embodiments, these exemplary processes and system enhance the durability of the acrylic or other materials comprising the artificial dentition structure 150 and/or offset gingival overlay denture 400. In some example embodiments, said artificial dentition structure 150 is electronically defined to achieve balanced occlusion, in accordance with the principles disclosed herein. For example, at least a portion and/or layer of said artificial dentition structure 150 may be offset to achieve balanced occlusion.

In various embodiments, various material is cured by exposure to heat and/or pressure. In various embodiments, said material is cured by exemplary processes and systems disclosed in U.S. patent application Ser. No. 13/369,238, PROCESSES AND SYSTEMS FOR MOLDING THERMOSETTING PLASTICS, which are incorporated by reference.

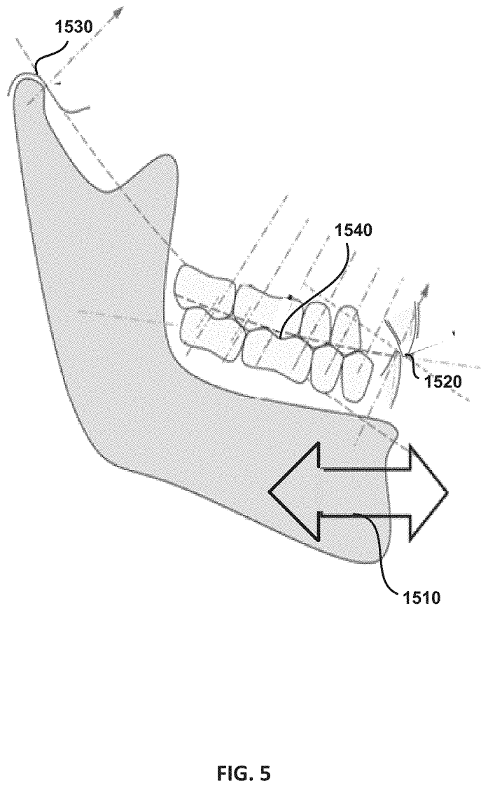

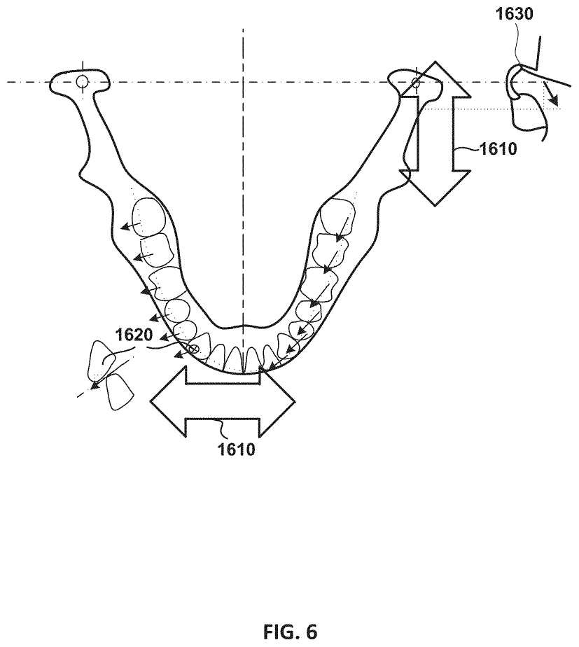

In one example embodiment, machining and/or manufacturing is in accordance with a three-dimensional file of the patient's anatomy. For example, in one example embodiment, a denture may be manufactured with consideration for balanced occlusion of the denture when used by a denture user. In one embodiment, artificial dentition structure 150 is electronically defined by computer modeling wherein aspects of the denture are designed by defining the motion envelope of the user's mandible and shaped to accommodate that motion while remaining in proper occlusal relationship through much or all of the motion. In one example embodiment, each feature may be defined by prismatic or other geometry. Furthermore, with reference to FIGS. 5 and 6, in one example embodiment, the motion envelope may be defined in protrusion 1510 from centric relation (mandible fully retracted) to protrusion 1510 where the central incisors are edge-to-edge. In one example embodiment, the motion envelope may be defined in laterotrusion 1610 where the buccal cusps of the posterior teeth are vertically aligned. Among other possible constraints, the mandible motion may be constrained in protrusion 1510 by incisal guidance 1520 and condylar shape 1530 and in laterotrusion 1610 by canine guidance 1620 and condylar shape 1630.

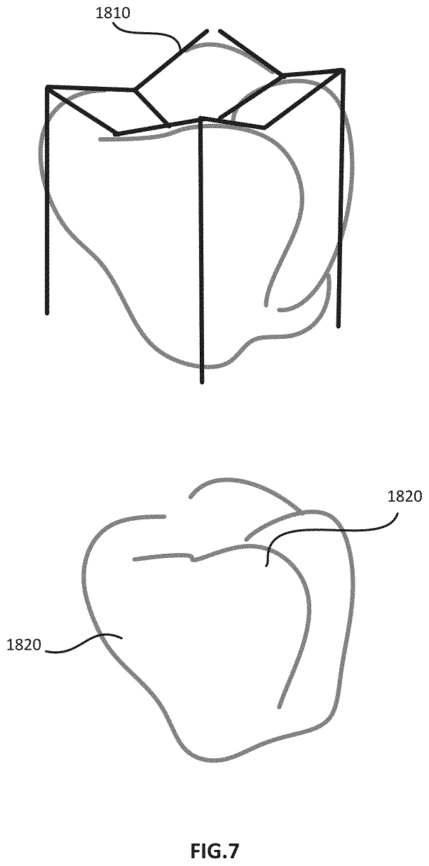

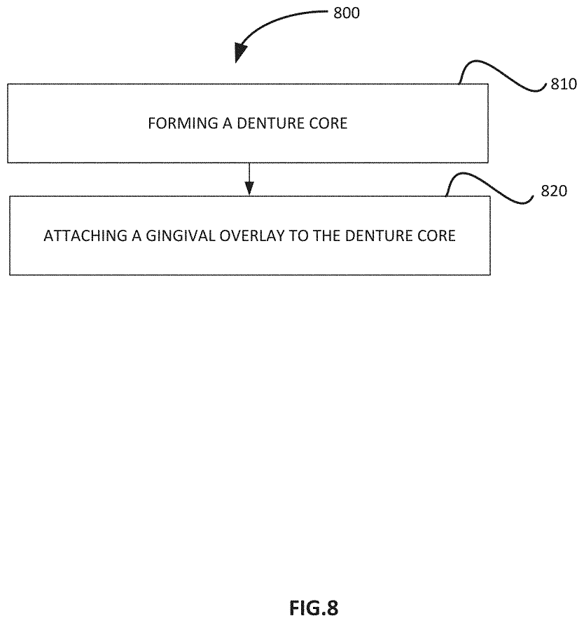

With reference to FIG. 7, in one example embodiment, the shape of artificial dentition structures 150 is defined for the mandible motion envelope and the thickness and shape of an artificial dentition structure 150 is offset 1810 to provide sufficient spacing for balanced occlusion to be achieved. Thus, an artificial dentition structure 150 may be electronically defined and may be built based on digital images of the patient's anatomy which takes account of the mandible motion envelope and the offsets to achieve balanced occlusion. In one example embodiment, no grinding on the occlusal surface (See FIG. 5; 1540) of the artificial dentition structure 150 will be required, due, for example, to this electronic definition (See FIG. 7, 1810). In one example embodiment, this may result in a more aesthetically pleasing denture wherein the denture does not exhibit localized weakening due to grinding away of material. In one example embodiment, additional tooth morphology 1820 may be added, for example, for aesthetic purposes or for any other purpose.

The process for manufacturing offset gingival overlay dentures 400 may be implemented by an apparatus as describing below. Moreover, it is to be expressly understood that any other systems or apparatus may also implement the process of the present invention.

In various embodiments, with reference to FIG. 8, a method 800 of manufacturing a gingival overlay denture may include forming a denture core (step 810) and attaching a gingival overlay to the denture core (step 820).

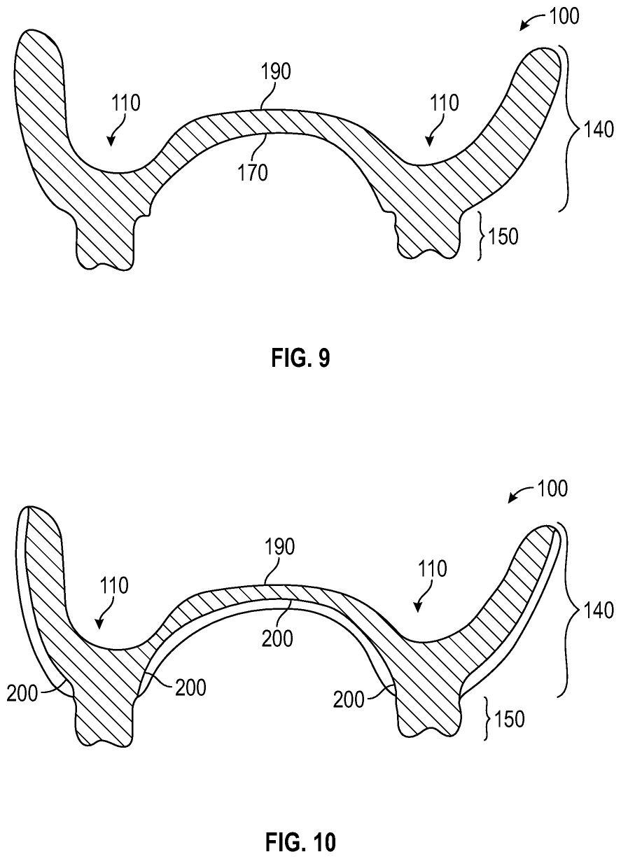

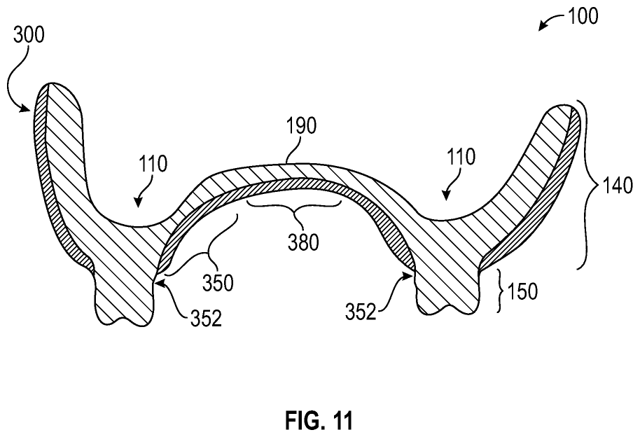

In an embodiment of the invention, FIGS. 9-11 disclose cross-sectional views of a denture core. FIG. 9 shows a denture core 100 having a dentition structures 150 and a gingival core 140, and in an embodiment of the invention, denture core comprises an artificial tooth material. FIG. 10 shows the denture core 100 having reductions applied to offsets 200 of the denture core 100. FIG. 11 illustrates the denture core 100 having gingival overlays 300 applied to the offsets 200 of the denture core 100, so that the resulting product resembles a fully realized and functional denture.

In one instance, a fixture for holding the offset gingival overlay denture 400 during manufacturing may be located adjacent to a material removing device. In some instances, the material removing device is a CNC or a CAD/CAM mill, although the material removing device can be a mill, grinder, laser cutter, or any other suitable device for forming the structures of the offset gingival overlay denture 400. In some instances, the material removing device and the fixture are movable relative to one another. In some instances, adjacent to the fixture may be at least one material delivery device to deliver raw material for the filling process described herein. An offset gingival overlay denture 400 may be further improved by adding a simulated root structure. Various features may be formed by additive manufacturing, or by manual manipulation, such as the addition of the gingival overlay over the denture core, or other methods as desired.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “proximate,” “proximately,” or any other variation thereof, are intended to cover a physical connection, an electrical connection, a magnetic connection, an optical connection, a communicative connection, a functional connection, and/or any other connection. When language similar to “at least one of A, B, or C” is used, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A gingival overlay denture comprising:
a denture core having tooth material, and comprising:
a gingival core having an overlay layer configured from removed portions of the denture core, the gingival core further having a gingival overlay comprising a layer of material configured to mimic natural gingiva, the gingival overlay being applied to the overlay layer.

2. The gingival overlay denture of claim 1, wherein the gingival core further comprises:
a lingual surface;
a hard palate surface; and
a buccal-facial surface;
wherein the overlay layer further comprises:
a lingual layer comprising a cutaway area of the lingual surface of the gingival core;
a hard palate layer coincident with the hard palate surface; and
a buccal-facial layer comprising a cutaway area of the buccal-facial surface.

3. The gingival overlay denture of claim 2,
wherein the buccal-facial layer is at least partially bounded by a buccal-facial dentition chamfer configured to provide a transition from the buccal-facial surface of the gingival core to an artificial dentition structure.

4. The gingival overlay denture of claim 2,
wherein the lingual layer is at least partially bounded by a lingual dentition chamfer configured to provide a transition from the lingual surface of the gingival core to an artificial dentition structure.

5. The gingival overlay denture of claim 2,
wherein the hard palate layer is at least partially bounded by the lingual surface of the gingival core.

6. The gingival overlay denture of claim 2, wherein the gingival overlay comprises:
a buccal-facial overlay comprising a portion of the gingival overlay coincident with the buccal-facial layer.

7. The gingival overlay denture of claim 6, wherein the buccal-facial overlay covers at least a portion of the buccal-facial surface and at least partially fills the buccal-facial layer.

8. The gingival overlay denture of claim 7, wherein the buccal-facial overlay comprises a buccal-facial-dentition interface edge comprising a terminal edge of the buccal-facial overlay proximate to an artificial dentition structure whereby a smooth transition between the buccal-facial overlay and the artificial dentition structure is achieved.

9. The gingival overlay denture of claim 2, wherein the gingival overlay comprises:
a lingual overlay comprising a portion of the gingival overlay coincident with the lingual layer.

10. The gingival overlay denture of claim 9, wherein the lingual overlay covers at least a portion of the lingual surface and at least partially fills the lingual layer.

11. The gingival overlay denture of claim 10, wherein the lingual overlay comprises a lingual-dentition interface edge comprising a terminal edge of the lingual overlay proximate to an artificial dentition structure whereby a smooth transition between the lingual overlay and the artificial dentition structure is achieved.

12. The gingival overlay denture of claim 2, wherein the gingival overlay comprises:
a hard palate overlay comprising a portion of the gingival overlay coincident with the hard palate layer.

13. The gingival overlay denture of claim 12, wherein the hard palate overlay covers at least a portion of the hard palate surface and at least partially fills the hard palate layer.

14. The gingival overlay denture of claim 13, wherein the hard palate overlay comprises a palatine raphe apex comprising a region of thickening corresponding to a location of a natural palatine raphe.

15. The gingival overlay denture of claim 1, wherein the denture core further comprises an edentulous ridge interface surface comprising a shape corresponding to a patient's edentulous ridge.

16. The gingival overlay denture of claim 15, wherein the edentulous ridge interface surface comprises at least one hamular notch interface surface comprising a shape corresponding to a patient's hamular notch.

17. A denture core comprising:
a gingival core having an overlay layer configured from removed portions of the denture core, the gingival core further having a gingival overlay comprising a layer of material configured to mimic natural gingiva, the gingival overlay being applied to the overlay layer to support a gingival overlay; and an artificial dentition structure formed integrally with the gingival core.

18. The denture core according to claim 17,
wherein the gingival core further comprises:
a lingual surface;
a hard palate surface; and
a buccal-facial surface; and
wherein the overlay layer further comprises:
a lingual layer comprising a cutaway area of the lingual surface of the gingival core;
a hard palate layer coincident with the hard palate surface; and
a buccal-facial layer comprising a cutaway area of the buccal-facial surface.

19. A method of making a gingival overlay denture comprising:
forming a denture core comprising:
a gingival core configured to support a gingival overlay; and
an overlay layer comprising a surface layer of the gingival core configured to receive the gingival overlay; and
attaching the gingival overlay to the denture core.

20. The method of making a gingival overlay denture of claim 19,
wherein the gingival core further comprises:
a lingual surface;
a hard palate surface; and
a buccal-facial surface;
wherein the overlay layer further comprises:
a lingual layer comprising a cutaway area of the lingual surface of the gingival core;
a hard palate layer coincident with the hard palate surface; and
a buccal-facial layer comprising a cutaway area of the buccal-facial surface;
wherein the gingival overlay comprises:
a buccal-facial overlay;
a lingual overlay;
a hard palate overlay;
wherein the step of attaching the gingival overlay to the denture core further comprises:
attaching the buccal-facial overlay to the buccal-facial surface coincident with an buccal facial layer;
attaching the lingual overlay to the lingual surface coincident with the lingual layer; and
attaching the hard palate overlay to the hard palate surface coincident with a hard palate layer.
